(19) United States
(12) Patent Application Publication
(10) Pub. No.: US 2004/0149144 A1
(43) Pub. Date: Aug. 5, 2004

(54) Barbecue apparatus

(76) Inventor: Mathuloe William Qubeka, Johannesburg (ZA)

Correspondence Address: Normvuyo Qubeka, 2411 Jones Lane, Silver Spring, MD, 20902, US

(21) Appl. No.: 10/668,440

(22) Filed: Sep. 23, 2003

(30) Foreign Application Priority Data
Sep. 23, 2002 (ZA) 2002/7619
Sep. 23, 2002 (ZA) 2002/9082

(51) Int. Cl. A47J 9/00

(52) U.S. Cl. 99/450; 99/482

(57) ABSTRACT

Barbecue apparatus is provided comprising a support structure, a fire basket, and an optionally removable and adjustable cooking grid operatively positioned above the fire basket. The fire basket is in the form of a generally squat horizontal rectangular enclosure comprising two spaced operatively horizontal mesh panels and a side panel extending between the edges of the two mesh panels along at least three sides thereof. The fire basket is supported in a manner, typically on an axle located centrally with respect of the front and back thereof, for enabling it to be inverted during the combustion of solid fuel contained therein about an axis that is generally parallel to any open region between the edges of the two mesh panels. The fire basket is preferably open along one side that is maintained uppermost when inverting the fire basket for use and which can be directed lowermost to empty the fire basket.

### FIELD OF THE INVENTION

This invention relates to barbecue apparatus and, more particularly, barbecue apparatus of the type that may be fuelled by solid fuels, particularly, but not exclusively, partly burnt solid fuels such as charcoal and charcoal briquettes.

### BACKGROUND TO THE INVENTION

Barbecue apparatus, as a general rule, has a grate on which a fire is made beneath a generally vertically adjustable horizontal cooking grid. The grate is usually in the form of a grid supported in a generally horizontal plane by a supporting frame, at least during operation of the barbecue apparatus.

When a fire is made on the grate some form of combustible starting material is generally placed on the grate and covered with, for example, a bed of charcoal, either before or after the combustible starting material is ignited. The procedure is then to wait until the charcoal has burnt from the bottom upwards until the uppermost pieces of charcoal are ignited and burning to a desired extent.

This procedure takes a long time. Also, the charcoal at the bottom of the bed of charcoal becomes substantially burnt out by the time that the fire is ready for use thereby resulting in what can be looked upon as a waste of charcoal that is fairly costly.

### OBJECT OF THE INVENTION

It is an object of this invention to provide barbecue apparatus in which, depending upon actual design, solid fuels such as charcoal can be conserved, at least to some extent, and the barbecue apparatus can be more rapidly rendered ready for cooking.

### SUMMARY OF THE INVENTION

In accordance with this invention there is provided barbecue apparatus comprising a support structure, a fire basket, and an optionally removable and adjustable cooking grid operatively positioned above the fire basket, the barbecue apparatus being characterized in that the fire basket is in the form of a generally squat, operatively horizontal rectangular enclosure comprising two spaced operatively horizontal mesh panels and a side panel extending between the edges of the two mesh panels along at least three sides thereof, the fire basket being supported in a manner enabling it to be inverted during the combustion of solid fuel contained therein about an axis that is generally parallel to any open region between the edges of the two mesh panels.

Further features of the invention provide for the means for inverting the fire basket to be pivotal means enabling the basket to be rotated through at least 180 degrees about a generally horizontal axis passing approximately through the centre of the fire basket; for the apparatus to include a hearth, conveniently in the form of an ash collecting tray that is preferably removable and located beneath the fire basket; for the support structure to be in the form of a fireproof cabinet the bottom of which conveniently supports said hearth and within which the fire basket is located; for the top of the cabinet to have an optionally removable surrounding shield within the confines of which is a generally vertically adjustable cooking grid; for the cooking grid to be supported on a pair of opposite upright slide and guide assemblies; and for the cooking grid to have a manipulating handle at each end thereof in which case the surrounding shield is provided with cutaway zones through the which the handles can pass, in use.

Preferably the space between one pair of corresponding side edges of the two mesh panels is left open so that the basket can be inverted by rotating it with the open side uppermost thereby preventing charcoal within the fire basket from falling out, and the fire basket can be emptied by rotating it in the opposite direction so that the open side can be located lowermost. Optionally, the fire basket can be divided in the operatively vertical direction into two juxtaposed fire basket compartments so that any one can be employed if a relatively short duration of cooking is envisaged and both can be employed if a longer duration of cooking is envisaged.

In order that the above and other features of the invention may be more fully understood one embodiment thereof will now be described with reference to the accompanying drawings.

### BRIEF DESCRIPTION OF THE DRAWINGS

In the drawings:—

FIG. 1 is an exploded perspective view of one embodyment of barbecue assembly according to the invention showing an access door open for illustration purposes; and,

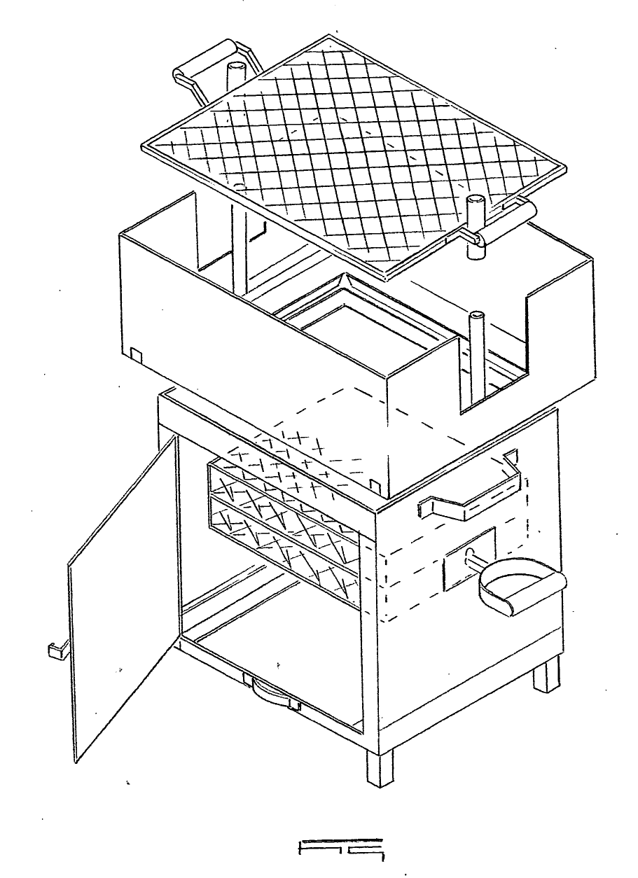

FIG. 2 is a schematic sectional front view illustrating the operation of the barbecue apparatus of the invention.

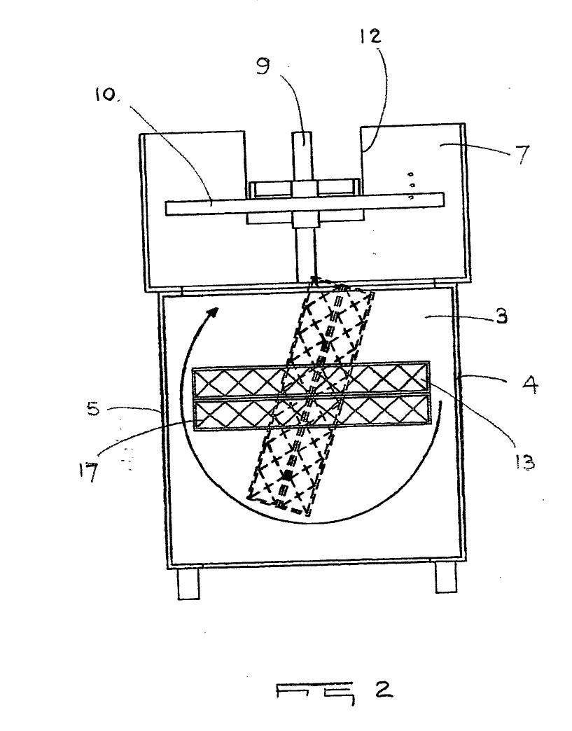

### DETAILED DESCRIPTION WITH REFERENCE TO THE DRAWINGS

In the embodiment of the invention-illustrated in the drawings the barbecue apparatus comprises a free standing cabinet (1) having a front wall (2), a rear wall (3), a fixed side wall (4), and a door (5) forming the other side wall thereof. The upper end of the cabinet is open as indicated by numeral (6) and the top of the cabinet receives a removable surrounding windshield (7).

The top of the cabinet also has a pair of oppositly located upwardly extending support posts (8) that cooperate with slides (9) fixed to a cooking grid (10) in a manner enabling the height of the cooking grid to be adjusted with respect to the cabinet. The cooking grid has handles (11) front and back to facilitate manual manipulation thereof and the shield has cutouts (12) through which the handles project so as to be easily accessible and protected from direct heat.

As provided by the invention, the apparatus has a square squat fire basket (13) rotatably supported within the cabinet beneath the open top thereof so that it can be rotated through 360 degrees. The pivotal support for the fire basket is composed of square cross-sectioned axles (14) extending centrally from the front and rear of the fire basket with the front axle terminating in an operating handle (15). An aperture (16) through the front wall of the cabinet has a keyhole shape so that the square cross-sectioned axle, when located in the rectangular lower portion of the keyhole shape, is held against rotation with the fire basket in one or other generally horizontal orientation.

The axle can be rotated in order to invert the fire basket only if the axle is raised to the circular upper portion of the keyhole shaped aperture when it can be rotated freely by means of the operating handle. Finally, as regards the fire basket, one side, indicated by numeral (17), is left open whilst the opposite side has a side wall that extends around the front and rear of the fire basket as well.

The fire basket can thus be charged with combustible material such as charcoal only through the open side (17) and this is generally achieved with the fire basket orientated with that side uppermost so that charcoal can be easily introduced into the fire basket

Beneath the fire basket is a removable ashtray (18) that serves also as a hearth for supporting combustible starting material and for catching ash that falls from the fire basket.

The side walls of the cabinet can be provided with any required ventilation holes that may also be provided with sliding closures so that the amount of air allowed to enter the cabinet can be controlled. This arrangement is not illustrated as it is a widely used expedient in combustion equipment.

In use, a fire starting material that is conveniently crumpled up newspaper or the like is ignited on the hearth with the fire basket in a horizontal orientation and charged with charcoal. The burning newspaper ignites the lower surface of charcoal rather rapidly and, also, the newspaper burns out rather rapidly. Once the flames have died down, the fire basket can be inverted using the operating handle so that the burning surfaces of the pieces of charcoal are directed upwards rather than downwards and cooking can proceed rather soon after the fire has been lit.

Inverting the fire basket must clearly take place with the open side of the fire basket passing through an upper region rather than a lower region of the cabinet so that the charcoal is not allowed to fall out. Also, because burning of the charcoal will proceed in a downwards direction and heat naturally rises, the charcoal will burn more slowly than would be the case if the burning region of each piece of charcoal were lowermost and burning took place in the direction of natural heat flow as in the case of all prior art barbecue apparatus of which applicant is aware.

When the fire has served its purpose the fire basket can be rotated so that the open side is directed downwards in order to discharge unburnt charcoal and ash from the fire basket onto the ashtray. The removable ashtray is then used to dispose of the ash and remaining charcoal.

Numerous variations may be made to the embodiment of the invention described above without departing from the scope hereof. In particular, the fire basket may be divided into two operatively horizontal compartments each of which has an open edge and each of which can receive charcoal independently of the other. Only one such compartment need be used in cases in which cooking is planned to take place over a rather short period of time and both compartments could be used if cooking is planned to take place over a more extended period of time. Also, if required, the open side of the fire basket could be provided with a closure in order to avoid loss of any charcoal through incorrect rotation of the fire basket. Still further, a suitable simple mechanism can be employed to prevent rotation of the fire basket in the incorrect direction unless certain preparatory steps are taken, such as to release a catch or the like.

1. Barbecue apparatus comprising a support structure, a fire basket, and an optionally removable and adjustable cooking grid operatively positioned above the fire basket, the barbecue apparatus being characterized in that the fire basket is in the form of a generally squat, operatively horizontal rectangular enclosure comprising two spaced operatively horizontal mesh panels and a side panel extending between the edges of the two mesh panels along at least three sides thereof, the fire basket being supported in a manner enabling it to be inverted during the combustion of solid fuel contained therein about an axis that is generally parallel to any open region between the edges of the two mesh panels.

2. Barbecue apparatus as claimed in claim 1 in which the means for inverting the fire basket are pivotal means enabling the basket to be rotated through at least 180 degrees about a generally horizontal axis passing approximately through the centre of the fire basket.

3. Barbecue apparatus as claimed in claim 2 in which the pivotal means includes an axle extending centrally outwards from the front and rear of the fire basket with at least one operating handle being provided at one end of the axle for rotating the fire basket.

4. Barbecue apparatus as claimed in any one of the preceding claims in which the apparatus includes a hearth in the form of an ash collecting tray that is removable and located beneath the fire basket.

5. Barbecue apparatus as claimed in any one of the preceding claims in which the support structure is in the form of a fireproof cabinet within which the fire basket is located.

6. Barbecue apparatus as claimed in claim 5 in which the top of the cabinet has an optionally removable surrounding shield within the confines of which is a generally vertically adjustable cooking grid.

7. Barbecue apparatus as claimed in any one of the preceding claims in which the cooking grid is supported on a pair of opposite upright slide and guide assemblies.

8. Barbecue apparatus as claimed in any one of the preceding claims in which the cooking grid has a manipulating handle at each end thereof in which case any surrounding shield is provided with cutaway zones through which the handles can pass, in use.

9. Barbecue apparatus as claimed in any one of the preceding claims in which the space between one pair of corresponding side edges of the two mesh panels is left open so that the basket can be inverted by rotating it with the open side uppermost thereby preventing charcoal within the fire basket from falling out, and the fire basket can be emptied by rotating it so that the open side is located lowermost.

10. Barbecue apparatus as claimed in any one of the preceding claims in which the fire basket is divided in the operatively vertical direction into two juxtaposed generally horizontal fire basket compartments so that either one can be employed if a relatively short duration of cooking is envisaged and both can be employed if a longer duration of cooking is envisaged.

11. Barbecue apparatus substantially as herein described and exemplified with reference to the accompanying drawings.
